(19) United States
(12) Patent Application Publication
(10) Pub. No.: US 2014/0334564 A1
(43) Pub. Date: Nov. 13, 2014

(54) METHOD AND SYSTEM FOR PROVIDING LOW-COMPLEXITY HYBRID PRECODING IN WIRELESS COMMUNICATION SYSTEMS

(71) Applicant: Samsung Electronics Co., Ltd., Suwon-si (KR)

(72) Inventors: Jaspreet Singh, Richardson, TX (US); Sudhir Ramakrishna, Plano, TX (US)

(73) Assignee: Samsung Electronics Co., Ltd, Suwon-si (KR)

(21) Appl. No.: 14/185,863

(22) Filed: Feb. 20, 2014

Related U.S. Application Data
(60) Provisional application No. 61/821,501, filed on May 9, 2013.

(51) Int. Cl. H04B 7/04

(52) U.S. Cl. CPC H04B 7/0404
USPC 375/267

(57) ABSTRACT

A method for providing low-complexity hybrid precoding is provided. The method includes identifying a subset of a plurality of precoding sets as a reduced search space. A search is performed over the reduced search space for a preferred precoding set. Identifying the reduced search space may include determining at least one parameter, such as received power, for each of a plurality of beam directions.

### CROSS-REFERENCE TO RELATED APPLICATION AND CLAIM OF PRIORITY

The present application is related to U.S. Provisional Patent Application No. 61/821,501, filed May 9, 2013, titled “LOW COMPLEXITY PRECODING 1N SYSTEMS WITH LARGE NUMBER OF ANTENNAS.” Provisional Patent Application No. 61/821,501 is assigned to the assignee of the present application and is hereby incorporated by reference into the present application as if fully set forth herein. The present application hereby claims priority under 35 U.S.C. §119(e) to U.S. Provisional Patent Application No. 61/821,501.

### TECHNICAL FIELD

The present application relates generally to wireless communications and, more specifically, to a method and system for low-complexity hybrid precoding in wireless communication systems.

### BACKGROUND

The use of the vast millimeter wave (mmwave) spectrum for high data rate mobile broadband communication has gained significant attention recently. The small carrier wavelengths at mmwave frequencies make it possible to synthesize highly directional antennas in compact form factors, thereby enabling link budgets that can overcome the significant propagation losses encountered in mmwave systems. For these systems, a hybrid analog/digital precoding architecture may be implemented to enable multi-stream data transmission using a mix of digital (baseband) and analog (radio frequency) processing. However, the complexity associated with such an architecture can make the use of hybrid precoding infeasible for even a relatively simple mmwave system.

### SUMMARY

This disclosure provides a method and system for providing low-complexity hybrid precoding in wireless communication systems.

In one embodiment, a method for providing low-complexity hybrid precoding is provided. The method includes identifying a subset of a plurality of possible precoding sets as a reduced search space. A search is performed over the reduced search space for a preferred precoding set.

In another embodiment, a method for providing low-complexity hybrid precoding is provided. The method includes determining at least one parameter for each of a plurality of beam directions. A subset of the beam directions is identified as dominant beam directions based on the at least one determined parameter. A search is performed over the dominant beam directions for a preferred precoding set.

In yet another embodiment, a user equipment (UE) is provided. The UE includes an array of sub-arrays of receive antennas, a radio frequency (RF) precoder, and a processing device. The RF precoder is configured to provide RF precoding for each of the sub-arrays of antennas. The processing device is configured to identify a subset of a plurality of precoding sets as a reduced search space and perform a search over the reduced search space for a preferred precoding set.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to an embodiment of this disclosure:

FIG. 2 illustrates an example user equipment (UE) according to an embodiment of this disclosure;

FIG. 3 illustrates an example eNodeB (eNB) according to an embodiment of this disclosure;

FIG. 4 illustrates an example transmitter configured to provide hybrid precoding according to an embodiment of this disclosure;

FIG. 5 illustrates an example system configured to provide hybrid precoding according to an embodiment of this disclosure;

FIGS. 6A-B illustrate example graphical representations of performances of low-complexity hybrid precoding compared to exhaustive hybrid precoding according to embodiments of this disclosure; and

FIG. 7 illustrates an example method for providing low-complexity hybrid precoding according to an embodiment of this disclosure.

### DETAILED DESCRIPTION

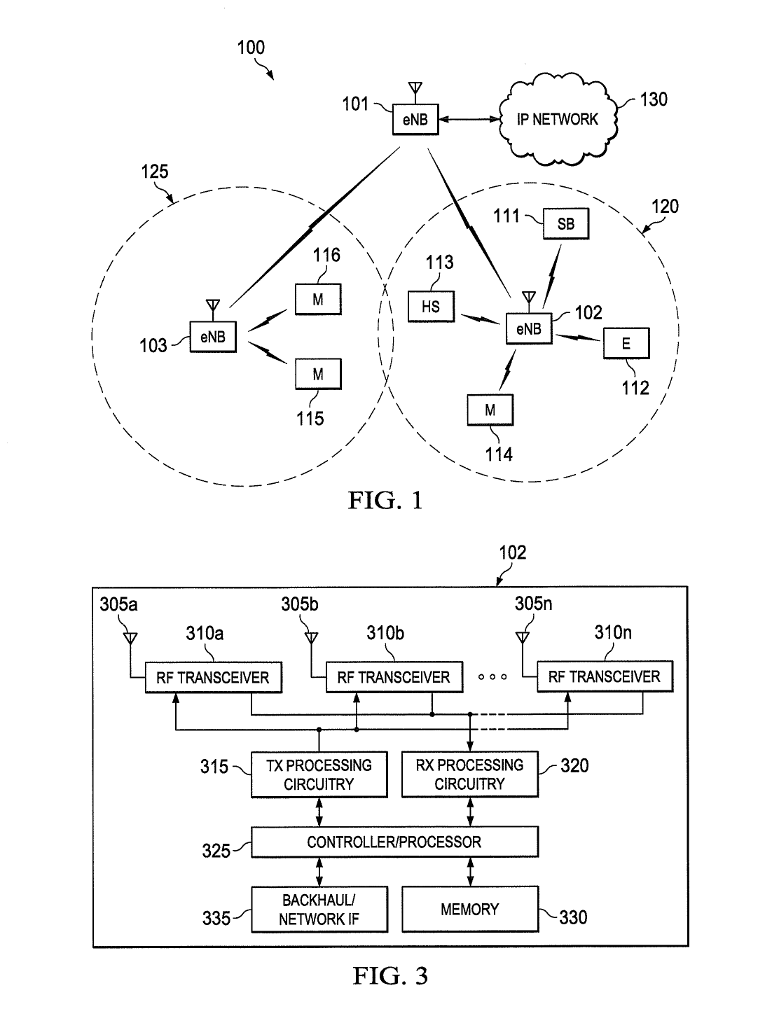

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using next generation (5G), LTE, LTE-A, WiMAX, WiFi, or other wireless communication techniques.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, components of the wireless network 100 (such as the eNBs 101-103 and/or the UEs 111-116) may be configured to perform hybrid precoding. For example, for some embodiments, the wireless network 100 may comprise a mmwave system. To reduce the cost and power consumption associated with mmwave RF and data conversion hardware, mmwave transceivers may utilize a hybrid analog/digital precoding architecture, which enables multi-stream data transmission using a mix of digital (baseband) and analog (RF) processing.

For some embodiments, codebook-based hybrid precoding may be implemented, where the RF and baseband precoders employed by the eNBs 101-103 and/or the UEs 111-116 are picked from specified codebooks. As in current cellular systems such as 3GPP LTE, this type of precoding may facilitate low overhead channel state information (CSI) feedback. For example, the UEs 111-116 may feed back indices corresponding to the optimal precoders, as opposed to analog feedback of the channel or the precoder.

However, the complexity of a brute-force approach to the hybrid precoder optimization problem is highly prohibitive, even for very reasonable system parameters. Therefore, as described in more detail below, low-complexity hybrid precoding procedures may be implemented.

It will be understood that, although the system and procedures are described in the context of communication with millimeter waves, they may be applied to other communication systems that employ beamforming (possibly using antenna arrays), and more generally, to systems that employ a code book based precoding mechanism.

As used in this document, the phrase “cellular band” refers to frequencies around a few hundred megahertz to a few gigahertz, and the phrase “millimeter-wave band” refers to frequencies around a few gigahertz (˜30 GHz) to a few hundred gigahertz. The radio waves in cellular bands may have less propagation losses and provide better coverage but may also use relatively small number of antennas. On the other hand, radio waves in millimeter-wave bands may suffer higher propagation losses but lend themselves well to high-gain antenna or antenna array designs in a small form factor.

One system design approach is to leverage existing technologies for mobile communication and utilize the millimeter-wave channel as additional spectrum for data communication. In this type of system, the eNBs 101-103 and the UEs 111-116 may communicate using both the cellular bands and the millimeter-wave bands. Compared with millimeter waves, radio waves in the cellular band suffer less propagation losses, can better penetrate obstacles, and are less sensitive to non-line-of-sight (NLOS) communication links or other impairments, such as absorption by oxygen, rain, and other particles in the air. Therefore, certain control channel signals may be transmitted via these cellular radio frequencies, while the millimeter waves may be utilized for high data rate communication. Alternate system designs are also possible, such as downlink (eNB to UE) communication in mmwave band and uplink (UE to eNB) communication in cellular band, or all communication in mmwave band. The methods disclosed here apply to all system designs employing codebook based hybrid precoding.

For some embodiments, as described in more detail below, the eNBs 101-103 and UEs 111-116 may each use an array of sub-arrays of antennas to carry out beamforming at each of the sub-arrays. A sub-array of antennas can form beams with different widths, such as wide beam or narrow beam. Downlink control channels, broadcast signals/messages, and/or broadcast data or control channels can be transmitted in wide beams. A wide beam may be provided by transmitting one wide beam at one time, a sweep of narrow beams at one time or at sequential times, or in any other suitable manner. Multicast and/or unicast data/control signals or messages can be sent in narrow beams.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

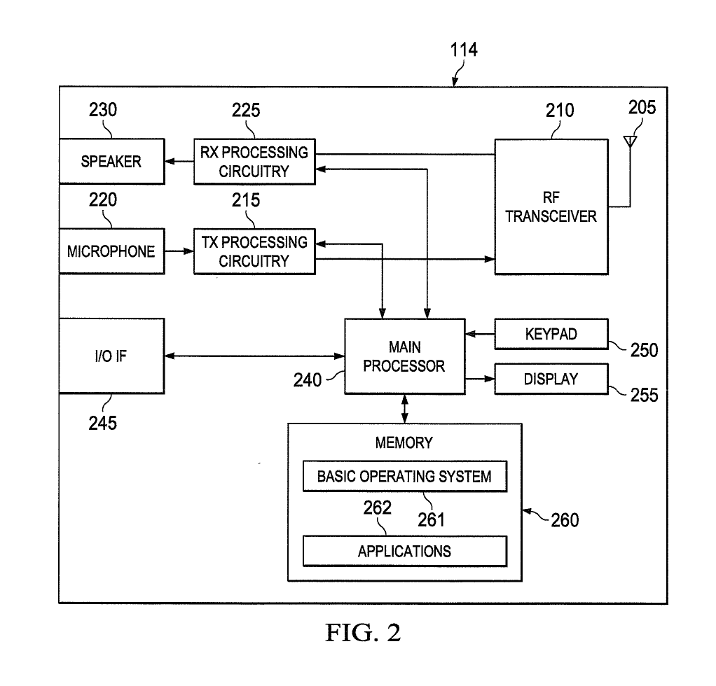

FIG. 2 illustrates an example UE 114 according to this disclosure. The embodiment of the UE 114 illustrated in FIG. 2 is for illustration only, and the other UEs in FIG. 1 could have the same or similar configuration. However, UEs come in a wide variety of configurations, and FIG. 2 does not limit the scope of this disclosure to any particular implementation of a UE.

As shown in FIG. 2, the UE 114 includes an antenna 205, a radio frequency (RF) transceiver 210, transmit (TX) processing circuitry 215, a microphone 220, and receive (RX) processing circuitry 225. The UE 114 also includes a speaker 230, a main processor 240, an input/output (I/O) interface (IF) 245, a keypad 250, a display 255, and a memory 260. The memory 260 includes a basic operating system (OS) program 261 and one or more applications 262.

As described in more detail below, the antenna 205 may include an array of sub-arrays of antennas. Thus, the antenna 205 may represent one or more sub-arrays, each including one or more antennas. Each sub-array of antennas may be configured to beamform signals received at and transmitted from the antenna 205.

The RF transceiver 210 receives, from the antenna 205, an incoming RF signal transmitted by an eNB or another UE. The RF transceiver 210 performs RF precoding and down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the main processor 240 for further processing (such as for web browsing data).

The TX processing circuitry 215 receives analog or digital voice data from the microphone 220 or other outgoing baseband data (such as web data, e-mail, or interactive video game data) from the main processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215, up-converts the baseband or IF signal to an RF signal, and performs RF precoding (i.e., beamforming at the various sub-arrays) on the RF signal that is transmitted via the antenna 205.

The main processor 240 can include one or more processors or other processing devices and can execute the basic OS program 261 stored in the memory 260 in order to control the overall operation of the UE 114. For example, the main processor 240 could control the reception of forward channel signals and the transmission of reverse channel signals by the RF transceiver 210, the RX processing circuitry 225, and the TX processing circuitry 215 in accordance with well-known principles. In some embodiments, the main processor 240 includes at least one microprocessor or microcontroller.

The main processor 240 is also capable of executing other processes and programs resident in the memory 260. The main processor 240 can move data into or out of the memory 260 as required by an executing process. In some embodiments, the main processor 240 is configured to execute the applications 262 based on the OS program 261 or in response to signals received from eNFBs, other UEs, or an operator. The main processor 240 is also coupled to the I/O interface 245, which provides the UE 114 with the ability to connect to other devices such as laptop computers and handheld computers. The I/O interface 245 is the communication path between these accessories and the main processor 240.

The main processor 240 is also coupled to the keypad 250 and the display unit 255. The operator of the UE 114 can use the keypad 250 to enter data into the UE 114. The display 255 may be a liquid crystal display or other display capable of rendering text and/or at least limited graphics, such as from web sites. The display 255 could also represent a touchscreen.

The memory 260 is coupled to the main processor 240. Part of the memory 260 could include a random access memory (RAM), and another part of the memory 260 could include a Flash memory or other read-only memory (ROM).

As described in more detail below, the applications 262 may include a low-complexity hybrid precoding application. The main processor 240 may be configured to execute this application 262, which can identify a subset of a plurality of precoding sets as a reduced search space and perform a search over the reduced search space for a preferred precoding set.

Although FIG. 2 illustrates one example of UE 114, various changes may be made to FIG. 2. For example, various components in FIG. 2 could be combined, further subdivided, or omitted and additional components could be added according to particular needs. As a particular example, the main processor 240 could be divided into multiple processors, such as one or more central processing units (CPUs) and one or more graphics processing units (GPUs). Also, while FIG. 2 illustrates the UE 114 configured as a mobile telephone or smartphone, UEs could be configured to operate as other types of mobile or stationary devices. In addition, various components in FIG. 2 could be replicated, such as when different RF components are used to communicate with the eNBs 101-103 and with other UEs.

FIG. 3 illustrates an example eNB 102 according to this disclosure. The embodiment of the eNB 102 illustrated in FIG. 3 is for illustration only, and other eNBs of FIG. 1 could have the same or similar configuration. However, eNBs come in a wide variety of configurations, and FIG. 3 does not limit the scope of this disclosure to any particular implementation of an eNB.

As shown in FIG. 3, the eNB 102 includes multiple antennas 305a-305n, multiple RF transceivers 310a-310n, transmit (TX) processing circuitry 315, and receive (RX) processing circuitry 320. The eNB 102 also includes a controller/processor 325, a memory 330, and a backhaul or network interface 335.

As described in more detail below, the antennas 305a-305n may include an array of sub-arrays of antennas. Thus, each antenna 305a-305n may represent a sub-array that includes one or more antennas. Each sub-array of antennas may be configured to beamform signals received at and transmitted from the sub-array.

The RF transceivers 310a-310n receive, from the antennas 305a-305n, incoming RF signals, such as signals transmitted by UEs or other eNBs. The RF transceivers 310a-310n perform RF precoding (i.e., beamforming at the various subarrays) and down-convert the incoming RF signals to generate IF or baseband signals. The IF or baseband signals are sent to the RX processing circuitry 320, which generates processed baseband signals by filtering, decoding, and/or digitizing the baseband or IF signals. The RX processing circuitry 320 transmits the processed baseband signals to the controller/processor 325 for further processing.

The TX processing circuitry 315 receives analog or digital data (such as voice data, web data, e-mail, or interactive video game data) from the controller/processor 325. The TX processing circuitry 315 encodes, multiplexes, and/or digitizes the outgoing baseband data to generate processed baseband or IF signals. The RF transceivers 310a-310n receive the outgoing processed baseband or IF signals from the TX processing circuitry 315, up-converts the baseband or IF signals to RF signals, and performs RF precoding on the RF signals that are transmitted via the antennas 305a-305n.

The controller/processor 325 can include one or more processors or other processing devices that control the overall operation of the eNB 102. For example, the controller/processor 325 could control the reception of forward channel signals and the transmission of reverse channel signals by the RF transceivers 310a-310n, the RX processing circuitry 320, and the TX processing circuitry 315 in accordance with well-known principles. The controller/processor 325 could support additional functions as well, such as more advanced wireless communication functions. For instance, the controller/processor 325 could support beam forming or directional routing operations in which outgoing signals from multiple antennas 305a-305n are weighted differently to effectively steer the outgoing signals in a desired direction. Any of a wide variety of other functions could be supported in the eNB 102 by the controller/processor 325. In some embodiments, the controller/processor 325 includes at least one microprocessor or microcontroller.

The controller/processor 325 is also capable of executing programs and other processes resident in the memory 330, such as a basic OS. The controller/processor 325 can move data into or out of the memory 330 as required by an executing process.

The controller/processor 325 is also coupled to the backhaul or network interface 335. The backhaul or network interface 335 allows the eNB 102 to communicate with other devices or systems over a backhaul connection or over a network. The interface 335 could support communications over any suitable wired or wireless connection(s). For example, when the eNB 102 is implemented as part of a cellular communication system (such as one supporting next generation (5G), LTE, or LTE-A), the interface 335 could allow the eNB 102 to communicate with other eNBs over a wired or wireless backhaul connection. When the eNB 102 is implemented as an access point, the interface 335 could allow the eNB 102 to communicate over a wired or wireless local area network or over a wired or wireless connection to a larger network (such as the Internet). The interface 335 includes any suitable structure supporting communications over a wired or wireless connection, such as an Ethernet or RF transceiver.

The memory 330 is coupled to the controller/processor 325. Part of the memory 330 could include a RAM, and another part of the memory 330 could include a Flash memory or other ROM.

As noted above, the eNB 102 could communicate with a UE, such as UEs 111-116, employing a hybrid precoding framework. The various components in this framework, such as the RF beams used at the eNB and at the UE, could be optimized by the UE and fed back to the eNB. For example, as described in more detail below, a UE may determine at least one beam parameter for each possible beamforming beam direction (at the eNB and at the UE) based on reference symbols received from the eNB 102, identify a number of dominant beam directions based on the determined parameters, and perform a low-complexity search for a preferred precoding set over the dominant beam directions. The UE may then notify the eNB 102 of the preferred precoding set.

Although FIG. 3 illustrates one example of an eNB 102, various changes may be made to FIG. 3. For example, the eNB 102 could include any number of each component shown in FIG. 3. As a particular example, an access point could include a number of interfaces 335, and the controller/processor 325 could support routing functions to route data between different network addresses. As another particular example, while shown as including a single instance of TX processing circuitry 315 and a single instance of RX processing circuitry 320, the eNB 102 could include multiple instances of each (such as one per RF transceiver).

For some embodiments, spatial multiplexing, or transmission of multiple data streams simultaneously, may be implemented. In current multiple input/multiple output (MIMO) cellular systems, multi-stream data transmission is accomplished by way of performing baseband precoding. For instance, for downlink transmission in 3GPP LTE, an eNB precodes the data to be transmitted on different streams using a baseband precoder (picked from a specified codebook of precoders), and the precoder outputs are fed into different transmit antennas using a separate RF chain (including a digital-to-analog converter, upconversion components and the like) for each antenna.

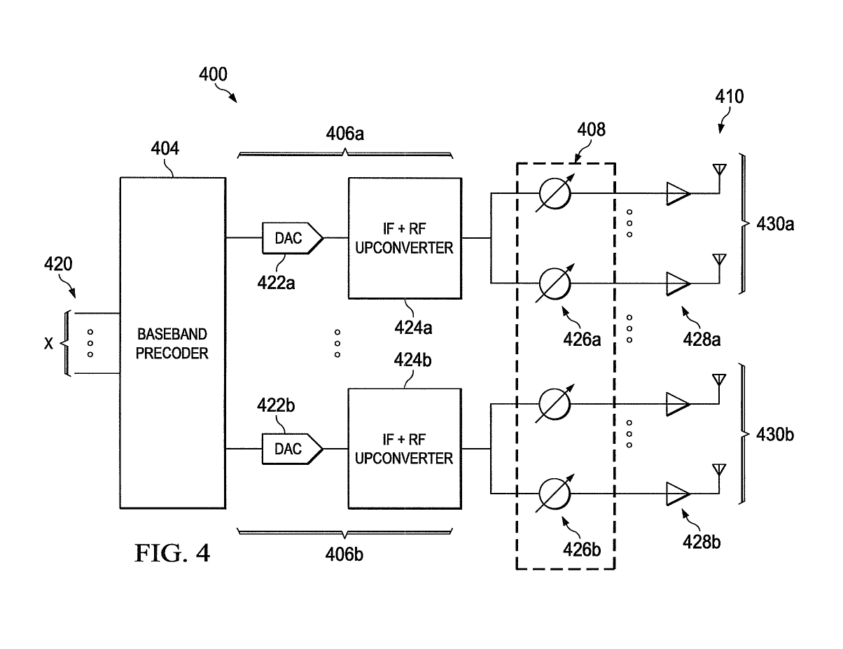

For millimeter-wave systems employing large antenna arrays, such an architecture could be infeasible due to the prohibitive cost of the large number of RF chains. Rather, as described below in connection with FIG. 4, an attractive implementation for a mmwave transceiver may include an array of sub-arrays. In this architecture, each RF chain feeds into a sub-array of antennas (rather than into a separate antenna element), with each sub-array configured to perform electronic beam steering (i.e., RF precoding) using a set of RF phase shifters. As a result, each sub-array may emulate a virtual antenna that is capable of directional transmission. For a specified minimum number of sub-arrays at both the transmitter and the receiver, multi-stream transmission can be supported for up to that minimum number of data streams. In addition to the RF beamforming at each sub-array, a baseband precoder is also employed to process the data to be sent on different streams, providing an additional level of flexibility on top of the phase-shift operations performed at RF.

Hybrid analog/digital precoding for mmwave systems involves a joint optimization over the choice of the baseband precoder and the RF precoder employed at the transmitter and the RF precoder employed at the receiver. In a codebook-based framework, a straightforward approach would be to perform this joint optimization by searching all possible combinations of the transmitter RF and baseband (BB) precoders and the receiver RF precoder. However, as shown below, the complexity of such an approach scales exponentially with the number of sub-arrays employed at the transmitter and the receiver. The number of combinations scales rapidly enough to make this approach prohibitive, even for reasonable system parameters.

Therefore, a reduced complexity algorithm for precoding in mmwave systems may be implemented, by way of reducing the search space for a preferred precoding set (such as a particular combination of the transmitter RF precoder, the transmitter BB precoder, and the receiver RF precoder). In particular, mmwave channels are typically characterized by a sparse multipath structure, which in the spatial domain corresponds to a small number of dominant angles of departure (AoDs) from the transmitter and a small number of dominant angles of arrival (AoAs) at the receiver. This motivates a possible reduction in the search space for the RF precoders (such as the beamforming directions) employed at the transmitter and the receiver, thereby reducing the complexity of precoder selection. For example, exploiting available downlink reference symbol-based channel measurements, the reduced search space may be obtained as disclosed here. The disclosed method can achieve performance close to that attained with an exhaustive search over all precoder combinations while providing an exponential reduction in the precoder selection search space.

FIG. 4 illustrates an example transmitter 400 configured to provide hybrid precoding according to an embodiment of this disclosure. The transmitter 400 shown in FIG. 4 is for illustration only. Other embodiments of the transmitter 400 could be used without departing from the scope of this disclosure.

For the illustrated embodiment, the transmitter 400 includes a BB precoder 404, a plurality of RF chains 406a-406b, an RF precoder 408, and an antenna array 410. It will be understood that the transmitter 400 includes additional components not illustrated in FIG. 4.

The BB precoder 404 may be configured to receive an input 420 that includes an N_{L} dimensional vector (x) comprising the data to be transmitted across the N_{L} layers, or data streams, for transmission from the transmitter 400. The BB precoder 404 is configured to apply baseband precoding to the input 420. For example, the BB precoder 404 may be configured to apply a specified matrix to the input 420 to generate an output. For some embodiments, the specified matrix may be selected from a codebook by either the transmitter 400 or a receiver, as described in more detail below.

Each RF chain 406a-406b includes a chain of elements. For example, each RF chain 406a-406b may include a digital-to-analog converter (DAC) 422a-422b and an IF+RF upconverter 424a-424b (comprising frequency mixers and filters). It will be understood that each RF chain 406a-406b may include any other suitable components. Each RF chain 406a-406b is configured to process one of the outputs of the BB precoder 404. For example, the output may be converted from a digital signal to an analog signal and then upconverted, in addition to having any other suitable processing performed.

The RF precoder 408 performs RF precoding (e.g., by phase-shifting the signals from the different RF chains). In the array of sub-arrays architecture, for each RF chain 406a-406b, the RF precoder 408 includes a set of phase shifters 426a-426b configured to shift the phase of signals output by the RF chain 406a-406b.

The transmitter 400 may also include a set of power amplifiers 428a-428b for each set of phase shifters 426a-426b. Each set of power amplifiers 428a-428b is configured to amplify signals output by the corresponding set of phase shifters 426a-426b. The antenna array 410 includes a plurality of sub-arrays 430a-430b. Each sub-array 430a-430b includes one or more antennas. Each antenna in a sub-array 430a-430b is configured to transmit a signal output from a corresponding power amplifier in the set of power amplifiers 428a-428b. Thus, for the embodiment illustrated in FIG. 4, each sub-array 430a-430b has a corresponding RF chain 406a-406b, set of phase shifters 426a-426b, and set of power amplifiers 428a-428b.

In operation, for a particular example, the BB precoder 404 applies baseband precoding to an input 420 and generates an output that feeds into each RF chain 406a-406b. The first RF chain 406a converts the digital output to an analog signal in the DAC 422a and upconverts the analog signal in the IF+RF upconverter 424a. The first set of phase shifters 426a then phase-shifts the upconverted signal, and the first set of power amplifiers 428a amplifies the phase-shifted signals. Finality, the first sub-array 430a transmits the amplified signals in the beam direction corresponding to the phase-shifts applied by the first set of phase-shifters 426a. A similar procedure is performed for each of the other outputs generated by the BB precoder 404.

For some embodiments as described above, the BB and RF precoders at the transmitter 400 are picked from specified codebooks of precoders. This facilitates low overhead channel state information (CSI) feedback. For instance, for downlink transmission in frequency division duplex (FDD) systems, a transmitter (such as an eNB) may not rely on channel reciprocity to obtain accurate downlink CSI using uplink reference signals transmitted by a receiver (such as a UE). The receiver, however, obtains downlink CSI using downlink reference symbols transmitted by the transmitter. In a codebook-based precoding framework, the receiver can optimize the choice of the precoders from the specified codebooks and feed back indices to indicate the optimal choices, thereby decreasing feedback overhead as compared to analog feedback of the downlink channel coefficients.

Although FIG. 4 illustrates one example of a transmitter 400, various changes may be made to FIG. 4. For example, various components in FIG. 4 could be combined, further subdivided, or omitted and additional components could be added according to particular needs. In particular, as described above, the RF chains 406a-406b may include other suitable components.

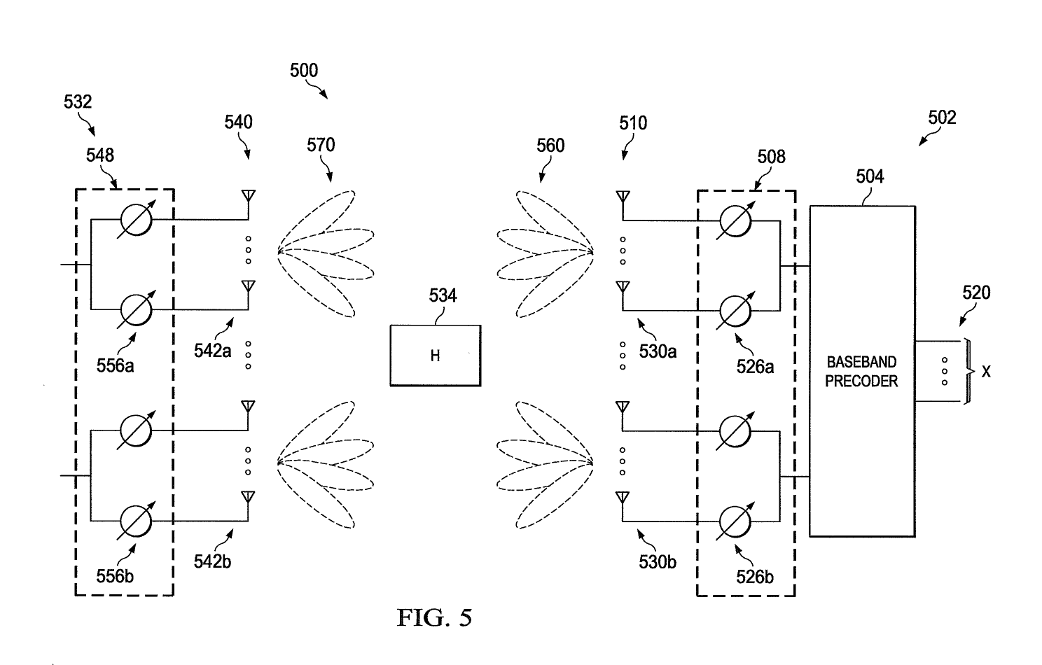

FIG. 5 illustrates an example system 500 configured to provide hybrid precoding according to an embodiment of this disclosure. The system 500 shown in FIG. 5 is for illustration only. Other embodiments of the system 500 could be used without departing from the scope of this disclosure.

The system 500 includes a transmitter 502 and a receiver 532. It will be understood that both the transmitter 502 and the receiver 532 include additional components not illustrated in FIG. 5. In the following description, the transmitter 502 may include an eNB, while the receiver 532 may include a UE. However, for some embodiments, the transmitter 502 and the receiver 532 may each include any other suitable component in a wireless communication system.

Similar to the transmitter 400, the transmitter 502 includes a BB precoder 504, an RF precoder 508, and an antenna array 510. The BB precoder 504 is configured to receive an input 520 including a plurality of layers, or data streams, and to apply a precoder matrix to the input 520 to generate a digital output. The RF precoder 508 includes a plurality of sets of phase shifters 526a-526b, each of which is configured to apply phase-shifts to a signal output from the BB precoder 504. It will be understood that these signals may be processed through an RF chain of elements (not shown in FIG. 5) before being provided to the RF precoder 508.

The antenna array 510 includes a plurality of sub-arrays 530a-530b, each of which is configured to transmit an output from a corresponding set of phase shifters 526a-526b in a direction based on the phase shift applied by the phase shifters 526a-526b. The illustrated embodiment includes a set of four possible beam directions 560 for each sub-array 530a-530b. Thus, for example, based on the phase shift of a signal received at a particular sub-array 530a-530b, the antennas in that sub-array 530a-530b may be configured to beamform the signal in a particular one of the four possible beam directions 560. It will be understood that the number of possible beam directions 560 may be any suitable number.

The signals transmitted by the antennas in the sub-arrays 530a-530b of the antenna array 510 pass through a channel 534, H, and arrive at the receiver 532. Similar to the transmitter 502, the receiver 532 includes an antenna array 540 of sub-arrays 542a-542b. Each sub-array 542a-542b is coupled to a corresponding set of phase shifters 556a-556b in an RF precoder 548. Thus, based on the phase shifts of the corresponding set of phase shifters 556a-556b, the antennas in a sub-array 542a-542b are configured to receive signals from the channel 534 in a particular beam direction 570. It will be understood that the signal received across a sub-array 542a-542b may then be processed through an RF chain of elements (not shown in FIG. 5), including the frequency downconverters (mixers, filters) and analog-to-digital converter (ADC).

The illustrated embodiment includes a set of four possible beam directions 570 for each sub-array 542a-542b. Thus, for example, the antennas in a sub-array 542a-542b may be configured to receive a signal in a particular one of the four possible beam directions 570 based on the phase shift applied by the corresponding set of phase shifters 556a-556b in the RF precoder 548. It will be understood that the number of possible beam directions 570 may be any suitable number.

For the description below, the following notation is used:

N_{SA}^{T}=number of sub-arrays 530a-530b at the transmitter 502

N_{SA}^{R}=number of sub-arrays 542a-542b at the receiver 532

N_{Ant}_{_{SA}}^{T}=number of antennas in each transmit sub-array 530a-530b

N_{Anti}_{_{SA}}^{R}=number of antennas in each receive sub-array 542a-542b

N_{Ant}^{T}=N_{SA}^{T}×N_{Ant}_{_{SA}}^{T}=total number of antennas at the transmitter 502

N_{Ant}^{R}=N_{SA}^{R}×N_{Ant}_{_{SA}}^{R}=total number of antennas at the receiver 532

H is the N_{Ant}^{R}×N_{Ant}^{T} MEMO channel, where each entry of H is a complex gain (an assumption valid, e.g., in a narrowband channel, such as the channel at one particular subcarrier in a MIMO-OFDM system)

N_{L} is the number of layers in the input 520 (such as the number of data streams)

F_{BB}^{T} is the NZ_{SA}^{T}×N_{L} baseband precoder matrix at the transmitter 502

F_{RF}^{T} is the N_{Ant}^{T}×N_{SA}^{T} RF precoder matrix at the transmitter 502

F_{RF}^{R} is the N_{Ant}^{R}×N_{AA}^{R} RF precoder matrix at the receiver 532.

If x is an N_{L}×1 vector of transmitted symbols and y is an N_{Ant}^{R}×1 vector of symbols received across the receiver antennas, then:

y=HF_{RF}^{T}F_{BB}^{T}x+w

where w is an N_{Ant}^{R}×1 noise vector having independent and identically distributed (i.i.d.) complex normal CN (0, σ²) entries. After RF precoding at the receiver 532 by the RF precoder 548, the N_{SA}^{R}×1 vector of symbols received across the receiver sub-arrays 542a-542b is:

z=F_{RF}^{R}*HF_{RF}^{T}x+F_{RF}^{R}*w.

For the array of sub-arrays architecture illustrated in FIG. 5, the RF precoder matrices used at the transmitter 502 and at the receiver 532 each possesses a particular structure. Since each sub-array 530a-530b or 542a-542b is coupled to one RF chain (not shown in FIG. 5), each column of the RF precoder matrix is zero except for a contiguous block of nonzero entries (corresponding to the beamforming weights used on the corresponding sub-array 530a-530b or 542a-542b). The beamforming vector in each column of the RF precoder matrix is assumed to have unit power so that:

F_{RF}^{R}*F_{RF}^{R}=I_{N}_{_{SA}}_{^{R}}

and

F_{RF}^{T}*F_{RF}^{T}=I_{N}_{_{SA}}_{^{T}}

where I_{M} is an identity matrix of dimension M. Consequently, the entries in the processed noise (such as F_{RF}^{R}*w) are still i.i.d. CN(0, σ²). Therefore:

z=F_{RF}^{R}*H_{RF}^{T}F_{BB}^{T}x+n

where n includes i.i.d. CN(0, σ²) entries.

Millimeter-wave channels are typically characterized by higher propagation losses and limited spatial scattering, as opposed to the rich scattering model often assumed for microwave frequencies. The (narrowband) spatial channel model, assuming a limited number (U) of scatterers between the eNB and the UE, is:

$$H = {\sum }_{u = 1}^{U} {g}_{u} {a}_{R} ( {α}_{u} ) {a}_{T}^{H} ( {β}_{u} ) ,$$

where gᵤ is the complex gain of the u^{th} channel path (path associated with the u^{th} scatterer) and αᵤ and βᵤ denote the azimuthal AoA at the receiver 532 and the azimuthal AoD from the transmitter 502 for the u^{th} path, respectively. The vectors a_{R}(•) and a_{T}(•) denote the array response at the receiver 532 and the transmitter 502, respectively. For a uniform linear antenna array with N antennas and antenna spacing d, the array response measured at an angle φ is:

$$a ( φ ) = \frac{1}{\sqrt{N}} {\{ 1 , {e}^{\frac{j 2 π}{λ} d sin φ} , … , {e}^{\frac{j 2 π}{λ} ( N - 1 ) d sin φ} \}}^{′} .$$

In hybrid precoding, the RF precoder matrices at the transmitter 502 and the receiver 532 and the baseband precoder matrix at the transmitter 502 are generally selected in a jointly optimal manner (for some appropriate measure of optimality, such as link throughput or the like). For some embodiments, the transmitter 502 does not have access to CSI and instead receives feedback regarding the precoder matrices to employ from the receiver 532. For instance, consider downlink transmission in FDD 3GPP LTE systems. Since channel reciprocity may not hold, the UE feeds back downlink CSI to the eNB based on channel estimates derived from downlink reference symbols (such as CSI-RS) transmitted by the eNB. To reduce the feedback overhead, the UE is generally constrained to optimize the choice of the baseband precoder matrix from a specified codebook of matrices and feeds back the corresponding optimal precoder matrix index to the eNB (no RF precoding, as described here, is performed in LTE systems). Similarly, for some embodiments of mmwave systems, the UE optimizes the choice of the RF precoders at the eNB and UE and the choice of the BB precoder at the eNB and feeds back the optimal choice to the eNB. For the embodiment described below, a codebook-based precoding framework may be implemented to facilitate low-overhead feedback.

For the array of sub-arrays architecture, RF precoding at each sub-array 530a-530b or 542a-542b involves beamforming towards a particular direction. (This can be implemented, for instance, using a set of progressive phase shifters in each sub-array, i.e., the phase shifts introduced by the different phase shifters within a sub-array vary in a linear fashion with the phase shifter index.) The coverage range (in azimuth) of the transmitter 502 may be denoted by R^{Tx}, and the coverage range (in azimuth) of the receiver 532 may be denoted by R^{Rx}. The codebook of beam directions at the transmitter 502 (or receiver 532) is the discrete set of directions spanning the range R^{Tx} (or R^{Rx}) in which the transmitter 502 (or receiver 532) can beamform. The codebook of RF beam directions at the transmitter 502 is:

$${C}_{RF}^{T} = \{ {φ}_{1}^{T} , {φ}_{2}^{T} , … , {φ}_{{N}_{Beams}^{T}}^{T} ) , ( {φ}_{i}^{T} ∈ {R}^{Tx} )$$

where N_{Beams}^{T} is the number of possible RF beam directions at the transmitter 502. Similarly, the codebook of RF beam directions at the receiver 532 is:

$${C}_{RF}^{R} = \{ {φ}_{1}^{R} , {φ}_{2}^{R} , … , {φ}_{{N}_{Beams}^{R}}^{R} ) , ( {φ}_{i}^{R} ∈ {R}^{Rx} )$$

where N_{Beams}^{R} is the number of possible RF beam directions at the receiver 532.

Each sub-array 530a-530b at the transmitter 502 (or sub-array 542a-542b at the receiver 532) can beamform toward any of the directions in C_{RF}^{T} (or C_{RF}^{R}). Thus, in terms of the RF precoder matrix at the transmitter 502 (or receiver 532), the nonzero vector in each column can be picked to be the beamforming vector corresponding to any of the directions in C_{RF}^{T} (or C_{RF}^{R}). For N_{SA}^{T} sub-arrays 530a-530b at the transmitter 502 (such as N_{SA}^{T} columns in F_{RF}^{T}), it follows that:

$${F}_{RF}^{T} ∈ {{C}_{RF}^{T}}^{{N}_{SA}^{T}} .$$

Similarly, for the receiver 532:

$${F}_{RF}^{R} ∈ {{C}_{RF}^{R}}^{{N}_{SA}^{R}} .$$

For this embodiment, the baseband precoder matrix at the transmitter 502 is also picked from a specified codebook of matrices. Specifically:

$${F}_{BB}^{T} ∈ {C}_{BB}^{T} = \{ {P}_{1}^{T} , {P}_{2}^{T} , … , {P}_{{N}_{BB}^{T}}^{T} \}$$

where C_{BB}^{T} is the codebook for the baseband precoder 504. This codebook includes N_{BB}^{T} number of possible precoder matrices, with the i^{th} matrix being Pᵢ^{T}. For this type of codebook-based precoding framework, the CSI feedback from the UE to the eNB would include an index corresponding to the eNB baseband precoder matrix and N_{SA}^{T} indices corresponding to the beam directions at the N_{SA}^{T} eNB sub-arrays 530a-530b.

In 3GPP LTE, systems, the UE feeds back the baseband precoder matrix index to the eNB based on channel estimates obtained from downlink CSI-RS transmitted by the eNB. Specifically, the eNB transmits a reference symbol from each transmit antenna so that the receive antennas can sense the channel from the different transmit antennas without any interference. Having estimated the channel from each transmit antenna to each receive antenna (such as having estimated the complete MIMO channel), the UE optimizes the choice of the eNB precoder matrix and feeds it back to the eNB.

For mmwave systems, the transmit and receive sub-arrays 530a-530b and 542a-542b can beamform in several possible directions 560 or 570. Consequently, CSI-RS may be transmitted from each sub-array 530a-530b at the transmitter 502 so as to enable channel measurements corresponding to different beam pair combinations at the transmit and receive sub-arrays 530a-530b and 542a-542b. In particular, for N_{Beams}^{T} number of possible beam directions 560 at the transmitter 502, and N_{Beams}^{R} number of possible beam directions 570 at the receiver 532, a particular transmit sub-array 542a-542b transmits N_{Beams}^{T}×N_{Beams}^{R} CSI-RS symbols. This allows the receiver 532 to measure (at each of its sub-arrays 542a-542b) the channel from the particular transmit sub-array 530a-530b corresponding to each beam pair combination. In other words, after scanning the CSI-RS symbols transmitted by each transmit sub-array 530a-530b, the receiver 532 can acquire (estimates of) the following channel coefficients:

h_{i,j,b}_{_{R}}_{,b}_{_{T}}

where h_{i,j,}_{_{R}}_{,b}_{_{T}} represents the channel between the receiver sub-array i and the transmitter sub-array j when the receiver sub-array i beamforms in the direction with beam index b_{R} and the transmitter sub-array j beamforms in the direction with beam index b_{T}. Note that, iε{1, 2, . . . , N_{SA}^{R}}, jε{1, 2, . . . , N_{SA}^{T}}, b_{R}ε{1, 2, . . . , N_{Beams}^{R}}, and b_{T}ε{1, 2, . . . N_{Beams}^{T}}. Thus, for these mmwave systems, the CSI-RS overhead scales as:

N_{SA}^{T}(N_{Beams}^{T}×N_{Beams}^{R})

since each transmit sub-array 530a-530b transmits (N_{Beams}^{T}×N_{Beams}^{R}) reference symbols.

Based on the CSI-RS channel measurements, the receiver 532 optimizes both the choices of the RF precoders 508 and 548 at the transmitter 502 and receiver 532 (such as the beam directions 560 and 570 used at the different sub-arrays 530a-530b and 542a-542b at the transmitter 502 and the receiver 532) and the choice of the baseband precoder 504 (such as the baseband precoder matrix) at the transmitter 502. For each choice of a particular precoding set, such as a BB/RF precoder combination at the transmitter 502 and an RF precoder at the receiver 532, an overall compressed channel is defined as:

H_{c}=F_{RF}^{R}*HF_{RF}^{T}F_{BB}^{T}

so that the transmission equation becomes:

z=H_{C}x+n.

Using the information theoretic measure of mutual information achieved over this channel as the optimization criteria, the optimization problem may be defined as follows:

$${argmax}_{{F}_{RF}^{R} ∈ {{C}_{RF}^{R}}^{{N}_{R}^{SA}} , {F}_{RF}^{T} ∈ {{C}_{RF}^{T}}^{{N}_{T}^{SA}} , {F}_{BB}^{T} ∈ {C}_{BB}^{T}} {log}_{2} ( det [ I + \frac{1}{{σ}^{2}} {H}_{C}^{*} {H}_{C} ] )$$

where I is the identity matrix. Other criteria for optimization may alternatively be used, and the disclosed methods for reduced complexity precoder search still apply. In particular, the disclosed methods to obtain the reduced precoder search space are not dependent on the optimization metric.

The receiver 532 can obtain the compressed channel H_{c} for each possible precoding set. Specifically, the set of beam direction indices employed at the transmit sub-arrays 530a-530b are denoted by:

$${b}_{T} = \{ {b}_{{T}_{1}} , {b}_{{T}_{2}} , … , {b}_{{T}_{{N}_{SA}^{T}}} \} .$$

Similarly, the set of beam direction indices employed at the receive sub-arrays 542a-542b are denoted by:

$${b}_{R} = \{ {b}_{{R}_{1}} , {b}_{{R}_{2}} , … , {b}_{{R}_{{N}_{SA}^{R}}} \} .$$

Thus, the compressed channel H_{c}, as a function of the transmit BB precoder matrix, is:

H_{c}(b_{R},b_{T},F_{BB}^{T})=H_{eff}(b_{R},b_{T})F_{BB}^{T}

where the N_{SA}^{R}×N_{SA}^{T} channel matrix H_{eff}(b_{R},b_{T}) is the effective channel seen between the transmitter 502 and receiver 532 when the transmit sub-arrays 530a-530b steer their beams in the directions 560 given by b_{T} and the receive sub-arrays 542a-542b steer their beams in the directions 570 given by h_{R}. The coefficients of this matrix are available based on CSI-RS measurements. Specifically:

$${H}_{eff} ( i , j ) = {h}_{i , j , {b}_{{R}_{i}} , {b}_{{T}_{j}}}$$

where h_{i,j,b}_{_{R}}_{,b}_{_{T}} is the channel between receive sub-array i and transmit sub-array j, when the receive sub-array i steers its beam in the direction of the beam index b_{R}_{ᵢ} and the transmit sub-array j steers its beam in the direction of the beam index b_{T}_{ⱼ}.

A direct approach to perform the preceding optimization at the receiver 532 is to evaluate the mutual information for each possible precoding set, such as each possible combination of the BB/RF precoders 504 and 508 at the transmitter 502 and the RF precoder 548 at the receiver 532. Since

$${F}_{RF}^{T} ∈ {{C}_{RF}^{T}}^{{N}_{SA}^{T}} ,$$

there are a total of

$${N}_{Beams}^{T} {N}_{T}^{SA}$$

possible choices for the transmit RF precoder 508 (each sub-array 530a-530b at the transmitter 502 can beamform towards any of the N_{Beams}^{T} directions). Similarly, there are a total of

$${N}_{Beams}^{R} {N}_{R}^{SA}$$

possible choices for the receive RF precoder 548. Since the BB precoder matrix at the transmitter 502 can be picked from among N_{BB}^{T} precoder matrices, the total number of combinations to consider is:

$$K = {N}_{Beams}^{R} {N}_{SA}^{R} \times {N}_{Beams}^{T} {N}_{SA}^{T} \times {N}_{BB}^{T} .$$

Thus, the total number of combinations scales exponentially with the number of sub-arrays 530a-530b and 542a-542b used at the transmitter 502 and the receiver 532. Even for reasonable values of the system parameters, the number of combinations makes an exhaustive search over all combinations prohibitive. For instance, for a simple system with four sub-arrays 530a-530b at the transmitter 502 and two sub-arrays 542a-542b at the receiver 532, and with eight possible beam directions 560 and 570 at each of the transmitter 502 and the receiver 532, the total number of combinations would be:

K=8²×8⁴×N_{BB}^{T}=2¹⁸×N_{BB}^{T}.

In contrast, for LTE precoder selection, a UE optimizes over the choice of only N_{BB}^{T} baseband precoders, which is itself known to make the CSI feedback computation module resource intensive. Therefore, given the much-increased complexity of an exhaustive search of each possible precoding set in a hybrid precoding system, a lower complexity, non-exhaustive approach may be used for precoder selection. For some embodiments, as described in more detail below, reduced-complexity precoder selection algorithms may be implemented. These could, for instance, be premised on the sparsity of the mmwave channel. In terms of the channel model described above, this implies that the number of dominant paths in the channel is expected to be small, i.e., the channel gains corresponding to a small number of paths dominate the channel gains of all other paths.

As described above in connection with FIG. 5, the major contribution to the high complexity of hybrid precoder selection comes from selection of the RF beam directions at the different sub-arrays at the transmitter 502 and the receiver 532. Because of the sparse nature of the mmwave channel, however, most of the energy is expected to be concentrated around a small set of spatial directions, namely the channel AoAs and AoDs of the dominant channel paths. Thus, if these AoAs and AoDs are known, the RF beam selection complexity can be reduced without significant performance degradation by mapping the AoAs and AoDs to the nearest beam directions in the transmitter and receiver codebooks and employing the resulting beam directions for communication.

However, even when the beam directions closest to the dominant channel AoAs and AoDs have been obtained, a determination regarding which sub-array at the receiver 532 and which sub-array at the transmitter 502 should beamform in which of those beam directions remains to be made. For the following description, it is assumed that the AoAs and AoDs corresponding to a specified number P of dominant channel paths are available.

For some embodiments, the beam directions closest to the channel AoAs and AoDs of the P dominant paths are obtained from among the codebooks of RF beamforming directions at the receiver 532 and at the transmitter 502. The resulting reduced-cardinality codebook at the receiver 532 may be denoted as \tilde{C}_{RF}^{R}, and the reduced-cardinality codebook at the transmitter 502 may be denoted as \tilde{C}_{RF}^{T}. An exhaustive search over each possible precoding set is then performed, while the set of RF beam directions at the receiver 532 is restricted to \tilde{C}_{RF}^{R}, and at the transmitter 502 is restricted to \tilde{C}_{RF}^{T}. In other words, the reduced cardinality codebooks \tilde{C}_{RF}^{T} and \tilde{C}_{RF}^{T}, are first obtained, and then the following reduced complexity optimization is performed:

$${argmax}_{{F}_{RF}^{R} ∈ {{\tilde{C}}_{RF}^{R}}^{{N}_{R}^{SA}} , {F}_{RF}^{T} ∈ {{\tilde{C}}_{RF}^{T}}^{{N}_{T}^{SA}} , {F}_{BB}^{T} ∈ {C}_{BB}^{T}} {log}_{2} ( det [ I + \frac{1}{{σ}^{2}} {H}_{C}^{*} {H}_{C} ] ) .$$

Since the cardinality of each of the RF beam direction codebooks has been reduced to P beam directions, the total number of combinations to consider in the preceding optimization is:

K_{P}=P^{N}^{_{SA}}^{^{R}}×P^{N}^{_{SA}}^{^{T}}×N_{BB}^{T}.

Therefore, significant corn plexity reduction can be attained since P may be small compared to the number of beam directions in the codebooks.

While picking the beam directions closest to the channel AoAs and AoDs of the P dominant paths from among the codebooks of RF beamforming directions at the receiver 532 and at the transmitter 502, procedures may be implemented to prevent repetition. For example, while picking receiver beam directions closest to two of the dominant AoAs, it is possible that both of these AoA directions map to the same beam in the receiver RF codebook. One possible approach aimed to prevent repetition is, for a given AoA direction, check if the beam direction closest to this AoA has already been obtained as being closest to another AoA direction and include it in the reduced search space only if the answer is no. While this approach tries to prevent repetition, it may be noted that whether one can obtain the desired number (P) of distinct beamformina directions from the specified codebook depends on the AoA/AoD values, in that it may happen that the knows AoAIAoD values end up mapping to less than P distinct codebook beams.

In the preceding embodiments, it was assumed that the receiver 532 knows the channel AoAs and AoDs corresponding to the P dominant channel paths and obtains the sets of P beams at the receiver 532 and the transmitter 502 by picking those codebook beam directions that are nearest to these AoAs and AoDs, respectively. Algorithms for direction estimation with large antenna arrays (while accommodating for the associated hardware constraints) are currently being investigated and have shown promising results (at least for estimating the AoA at the receiver). For a particular example, direction estimation may be performed using a compressed estimation framework. Thus, direction estimation in systems with large arrays is feasible.

For some other embodiments, instead of estimating precise AoAs and AoDs and then mapping them to the nearest beams in the codebooks, a procedure to directly obtain the P dominant beam directions may be performed without explicitly estimating the channel AoAs and AoDs. For these embodiments, the channel measurements made by the receiver 532 based on the standard CSI-RS symbols are used so that no extra reference symbol transmissions are needed to obtain the dominant beam directions.

Specifically, since most of the signal power is expected to be concentrated around a small set of spatial directions, those beam directions from the receiver and transmitter codebooks that capture the maximum signal power may be determined. The CSI-RS channel measurements provide an estimate of the signal strength across different beam pair combinations and across different sub-arrays at the receiver 532 and the transmitter 502. These estimates may be used to obtain an effective signal power estimate in the different beam directions in the receiver and transmitter codebooks, and the beams having the maximum effective powers at the receiver 532 and the transmitter 502 may be selected as the P dominant beams.

As described above, the typical channel measurement, made from the CSI-RS symbols is the channel estimate between sub-array i at the receiver 532 and sub-array j at the transmitter 502, when the receiver sub-array beamforms in the beam direction index b_{R} and the transmitter sub-array beamforms in the beam direction index b_{T}. To obtain an effective power estimate for beam index l at the receiver 532, the estimated power may be averaged across all channel coefficients with b_{R}=l. In this way, spatial smoothing may be performed across sub-arrays and beam pairs to obtain a more reliable estimate. For example, this effective power may be defined as:

$${P}_{eff}^{R} ( l ) = \frac{{\sum }_{i = 1}^{{N}_{SA}^{R}} {\sum }_{j = 1}^{{N}_{SA}^{T}} {\sum }_{{n}_{T} = 1}^{{N}_{Beams}^{T}} {\vert {h}_{i , j , l , {b}_{r}} \vert}^{2}}{( {N}_{SA}^{R} \times {N}_{SA}^{T} \times {N}_{Beams}^{T} )} , l ∈ \{ 1 , 2 , … , {N}_{beams}^{R} \} .$$

Once the effective power estimates are obtained for each beam direction in the receiver codebook, the P beams with the largest effective powers may be selected to be the P dominant beams at the receiver 532.

A similar procedure may be performed corresponding to the transmitter beam directions. Specifically, the effective powers for the transmitter beams may be defined as:

$${P}_{eff}^{T} ( k ) = \frac{{\sum }_{i = 1}^{{N}_{SA}^{R}} {\sum }_{j = 1}^{{N}_{SA}^{T}} {\sum }_{{b}_{R} = 1}^{{N}_{Beams}^{R}} {\vert {h}_{i , j , {k}_{R} , k} \vert}^{2}}{( {N}_{SA}^{R} \times {N}_{SA}^{T} \times {N}_{Beams}^{R} )} , k ∈ \{ 1 , 2 , … , {N}_{beams}^{T} \} .$$

Then, as with the receiver 532, the P beams with the largest effective powers may be selected to be the P dominant beams at the transmitter 502.

Using the preceding effective power method, the P dominant beam directions at the receiver and the transmitter may be obtained. The resulting reduced-cardinality codebook (comprising the P dominant beams) at the receiver 532 may be denoted as \tilde{C}_{RF}^{R}, and the reduced-cardinality codebook at the transmitter 502 may be denoted as \tilde{C}_{RF}^{T}. An exhaustive search over each possible precoding set is then performed, while the set of RF beam directions at the receiver 532 is restricted to \tilde{C}_{RF}^{R} and at the transmitter 502 is restricted to \tilde{C}_{RF}^{T}. In other words, the reduced cardinality codebooks \tilde{C}_{RF}^{T} and \tilde{C}_{RF}^{R} are first obtained using the effective power method, and then the following reduced complexity optimization is performed:

$${argmax}_{{F}_{RF}^{R} ∈ {{\tilde{C}}_{RF}^{R}}^{{N}_{R}^{SA}} , {F}_{RF}^{T} ∈ {{\tilde{C}}_{RF}^{T}}^{{N}_{T}^{SA}} , {F}_{BB}^{T} ∈ {C}_{BB}^{T}} {log}_{2} ( det [ I + \frac{1}{{σ}^{2}} {H}_{C}^{*} {H}_{C} ] ) .$$

Since the cardinality of each of the RF beam direction codebooks has been reduced to P beam directions, the total number of combinations to consider in the preceding optimization is:

K_{P}=P^{N}^{_{SA}}^{^{R}}×P^{N}^{_{SA}}^{^{T}}×N_{BB}^{T}.

Although the preceding embodiments described in connection with FIG. 5 illustrate examples of providing low-complexity hybrid precoding in a mmwave system, various changes may be made to these embodiments. For example, different numbers of beams may be included in the reduced search spaces of the transmitter 502 and the receiver 532. That is, the transmitter 502 may have a reduced search space of P₁ dominant beam directions, while the receiver 532 has a reduced search space of P₂ dominant beam directions, with P₁≠P₂.

In addition, the number of beams in the reduced search space may differ across sub-arrays. For example, a first sub-array at the transmitter 502 may have a reduced search space of P_{1,1} dominant beam directions, a second sub-array at the transmitter 502 may have a reduced search space of P_{1,2} dominant beam directions, and so on. Similarly, a first sub-array at the receiver 532 may have a reduced search space of P_{2,1} dominant beam directions, a second sub-array at the receiver 532 may have a reduced search space of P_{2,2} dominant beam directions, and so on.

Furthermore, the determination of the reduced search spaces for the transmitter 502 and the receiver 532 could be performed jointly (by computing an effective power for each transmit-receive beam pair combination, e.g., by averaging out the received signal power for this beam pair combination across the different transmit-receive sub-arrays) instead of separately, or the determination of the reduced search spaces for the transmitter 502 and the receiver 532 could be performed separately for each sub-array. Also, the determination of the reduced search spaces for the transmitter 502 and the receiver 532 could be performed in a conditional manner. For example, the dominant beam directions at the receiver 532 may be determined first. The dominant beam directions at the transmitter 502 may be determined in a manner limited to the dominant beam directions already determined for the receiver 532, instead of all possible beam directions for the receiver 532. Similarly, the dominant beam directions at the transmitter 502 may be determined first, followed by a determination for the receiver 532 that is limited to the beam directions determined for the transmitter 502.

In addition, for some embodiments, the transmitter 502 may transmit reference symbols only for the dominant beam paths to the receiver, instead of transmitting reference symbols for every possible beam path in the transmitter and receiver RF codebooks. In this way, CSI-RS overhead may be reduced.

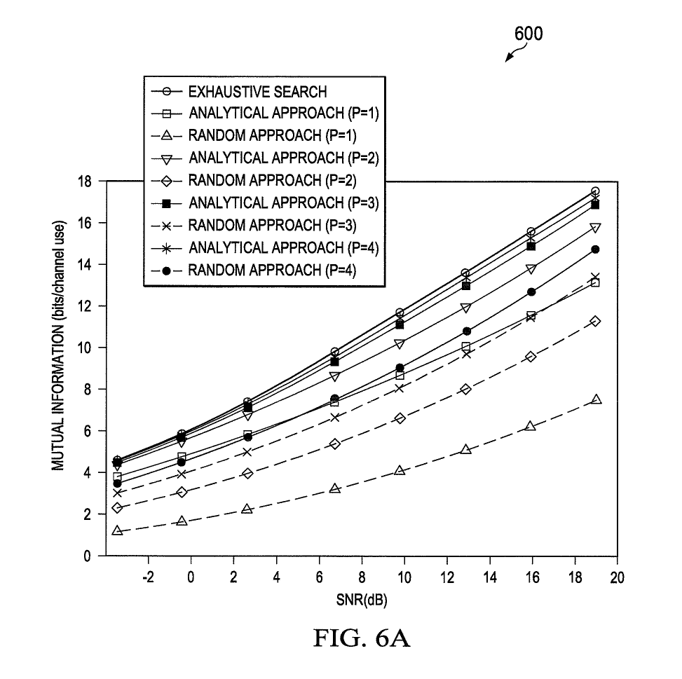

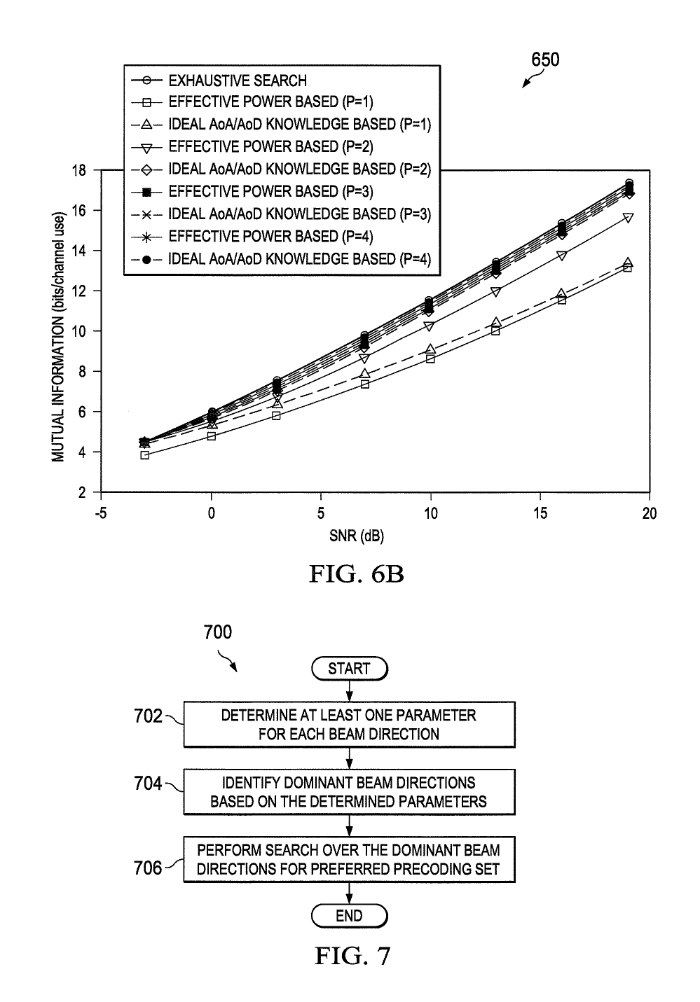

FIGS. 6A-B illustrate example graphical representations 600 and 650 of the performance of low-complexity hybrid precoding compared to exhaustive hybrid precoding according to embodiments of the disclosure. It will be understood that the graphical representations 600 and 650 shown in FIGS. 6A-B are for illustration only.

The system 500 described in connection with FIG. 5 is used in the following example. For this particular example, the transmitter 502 includes two sub-arrays 530a-530b and the receiver 532 includes two sub-arrays 542a-542b. The transmitter sub-arrays 530a-530b each include eight antennas, while the receiver sub-arrays 542a-542b each include four antennas.

The transmitter 502 includes a sector that spans 120° around boresight, while the receiver 532 is configured to monitor a 180° region around boresight. The RF codebook at the transmitter 502 includes eight beam directions 560 spread uniformly in the sector, while the RF codebook at the receiver 532 includes twelve beam directions 570 spread uniformly. The spatial channel model used to simulate the channel is:

$$H = {\sum }_{u = 1}^{U} {g}_{u} {a}_{R} ( {α}_{u} ) {a}_{T}^{H} ( {β}_{u} )$$

as described above in connection with FIG. 5.

The number of paths U in this example is six, with each of the six paths having equal average powers. The AoAs and AoDs of the six paths are distributed uniformly in the spatial range of the receiver 532 and the transmitter 502. The baseband precoder matrix is assumed to be selected from the 2×2 codebook used in the LTE standard.

Using these parameters, the graphical representation 600 of FIG. 6A illustrates the performance of low-complexity hybrid precoding compared to exhaustive hybrid precoding for different values of P (such as the number of dominant beam paths to be selected). These P dominant beam paths are selected based on the effective power metric described above. In addition, for comparison, the graphical representation 600 illustrates the performance of a random, reduced-complexity search, wherein the P beam directions 560 and 570 at the transmitter 502 and the receiver 532 are picked randomly from the RF codebooks at the transmitter 502 and the receiver 532, as opposed to being picked based on the effective power metric.

Thus, the graphical representation 600 illustrates the performance corresponding to an exhaustive search of all possible beam paths (such as optimal performance), the performance corresponding to an analytical selection of P dominant beam paths (based on the effective power metric), and the performance corresponding to a random selection of P beam paths. The performances of the selections of P beam paths, both analytical and random, are illustrated for P=1, 2, 3, 4. The values associated with these performances (except for P=1) are as follows:

| | | Loss compared | |
|---|---|---|---|
| | | to exhaustive | |
| Approach | Complexity | approach | |
| Exhaustive | 64,512 | n/a | |
| Analytical (P = 2) | 112 | 2.4 | dB |
| Random (P = 2) | 112 | 9 | dB |
| Analytical (P = 3) | 567 | 0.9 | dB |
| Random (P = 3) | 567 | 6.2 | dB |
| Analytical (P = 4) | 1,792 | 0.45 | dB |
| Random (P = 4) | 1,792 | 4.2 | dB |

The graphical representation 600 illustrates that close-to-optimal performance may be achieved while using P=3 (for example, at 10 dB SNR, performance is within 0.9 dB of the optimal performance). The number of precoder combinations evaluated in the analytical approach with P=3 is K₃=3²×3²×7=567 (the LTE BB codebook, used in this example, has cardinality 7), as opposed to the number of precoder combinations evaluated in the exhaustive search, which is K=12²×8²×7=64,512. Therefore, a significant complexity reduction (more than a factor of 100 reduction) is provided using the analytical approach, while negligible performance degradation occurs. For the same value of P, the performance with a random beam path selection is 6.2 dB worse than that of the exhaustive search.

For the graphical representation 650 illustrated in FIG. 6B, the performances of three schemes are compared: an exhaustive search over all precoder combinations (as in FIG. 6A), a reduced-complexity search based on the estimated dominant beam selection method (using effective power metric) described above, and a reduced-complexity search based on known AoA/AoD directions described above (where the P dominant AoA/AoD directions are mapped to the nearest beam directions in the receiver/transmitter RF codebooks, respectively, as disclosed in earlier embodiments). (The performance of random beam path selection is not shown in FIG. 6B.)

From the graphical representation 650, it is observed that, with ideal channel AoA/AoD knowledge (labeled: ideal analytical), at 10 dB SNR, using P=2, the performance is within 0.7 dB of the performance with an exhaustive search, while with P=3, the performance is within 0.25 dB of the performance with an exhaustive search. Note that with the effective power based dominant beam selection (labeled: estimated analytical), with P=3, the performance is within 0.9 dB of the performance with an exhaustive search.

FIG. 7 illustrates an example method 700 for providing low-complexity hybrid precoding according to an embodiment of this disclosure. The method 700 shown in FIG. 7 is for illustration only. A method for providing low-complexity hybrid precoding may be implemented in any other suitable manner without departing from the scope of this disclosure.

Initially, at Least one beam parameter is determined for each of a plurality of possible beam directions (step 702). For example, the at least one beam parameter may include an instantaneous power, an average power across sub-arrays, an average power across beam pairs, an effective power or the like.

Dominant beam directions are identified based on the determined parameters (step 704). For example, if the determined beam parameter is the effective power of each beam direction, the dominant beam directions may be identified by determining which beam directions have the highest effective powers. For some embodiments, a number, P, of dominant beam directions to be identified may be specified. Thus, for the effective power embodiment, the P beam directions having the highest effective powers may be identified as the dominant beam directions.

Methods to determine what value of the parameter P to pick are also considered. One approach could be to pick it based on the tolerable search complexity. In other words, for a given desired search complexity, the largest value of P that ensures the search complexity is within the desired limit may be picked. Note that, as described in preceding embodiments, different values of P may be used to obtain the reduced cardinality beam sets for the transmitter and the receiver (e.g., P1 for transmitter and P2 for receiver). In this case, it is possible to consider any such combination of P1 and P2 that results in a complexity which is still within the desired limits.

Another method to implicitly pick the value P could be as follows: Consider the receiver RF codebook (i.e., set of possible beam directions for the receiver). For each of the beams in this codebook, the effective power is calculated. Then, P is the size of the smallest subset of beams in this codebook that captures more than a certain fraction (say, Δ=<1) of the sum of the effective powers computed for the different beam directions in this codebook. For instance, Δ could be a large fraction, such as 0.95. A similar procedure could be used to obtain the value of P to be used for the transmitter codebook subset selection.

Another approach to pick P implicitly could be to apply a threshold on the computed effective powers. For instance, only those beams with effective power greater than a certain threshold value may be retained for the purpose of performing the precoder optimization search. Different thresholds may be used for the transmitter and receiver, as well as for different sub-arrays at the transmitter and the receiver. One possible choice of the threshold, for example, could be a certain fraction (less than 1) of the highest effective power amongst all the beams.

The preceding two embodiments illustrate implicit methods to pick P for the effective power based dominant beam selection. On the other hand, for the approach where the channel AoA and AoD values are used to pick the dominant beams (by mapping the AoAs and AoDs to the nearest codebook beams), similar methods can be employed if the estimates of the corresponding channel path gains are available. For instance, a threshold can be applied on the channel path gains, and only the AoAs and AoDs of channel paths with gains greater than the threshold can be considered for dominant beam selection.

Finally, a low-complexity search for a preferred precoding set is performed over the identified dominant beam directions (step 706). Thus, instead of performing an exhaustive search for a preferred precoding set, the search is performed over a reduced search space, such as the dominant beam directions, which greatly reduces the complexity of the search. Hybrid precoding may then be performed using the preferred precoding set identified by this search. In this way, hybrid precoding may be performed without the complexity of an exhaustive search, which makes standard hybrid precoding infeasible to implement in practice.

The hybrid precoding optimization problem involves a joint optimization of the baseband and RF precoders. In the preceding embodiments, a codebook based framework has been considered, wherein the baseband and RF precoders are picked from specified codebooks of precoders, and methods have been disclosed for reducing the complexity of such joint optimization by restricting attention to a subset of the possible RF precoders, as compared to an exhaustive set. The methods disclosed for obtaining the dominant RF precoder subset (via dominant beam selection) apply to other settings of interest as well. As an example, it is plausible that the choice of the RF and baseband precoders may not be performed jointly but sequentially: for instance, the choice of the RF precoders may be optimized first, and for the obtained optimal RF precoder choices, the baseband precoder may then be optimized (the baseband precoder could be picked from a codebook, or based on other techniques, such as a singular value decomposition (SVD) of the channel). As another example, the RF and baseband precoder optimization could still be performed jointly, but the baseband precoder may not be picked from a codebook (and rather picked based on techniques such as SVD). In all of these (and other plausible) hybrid precoding optimization approaches, the methods disclosed to obtain a subset of dominant RF precoders (via dominant beam selection) apply.

The principle of dominant beam selection described above (and implemented based on the disclosed effective power metric) may extend to other scenarios of interest as well. For instance, the phase shifts applied at the phase shifters in a particular sub-array (at the transmitter/receiver) need not necessarily be progressive phase shifts. In this situation, the RF precoding operation need not necessarily correspond to performing beamforming in a specific direction. Even in such applications, given a discrete codebook of possible RF precoding vectors (where the RF precoding vector specifies the operation performed at the RF level in each sub-array), the principles disclosed here are applicable to obtain a subset of dominant RF precoding vectors from the codebook (using the effective power metric or other parameters).

Further, the effective power metric disclosed here applies in general, and can be employed for selecting a subset of dominant beams from amongst a codebook of beams, even if the eventual purpose of such dominant beam selection may not be to reduce the complexity of hybrid precoding.

The above-described methods and procedures have focused on the azimuth plane transmission only. However, all the concepts extend to elevation dimension as well. In particular, for codebook-based beamforming in the elevation dimension, the principles of obtaining a reduced cardinality beam set as well as using the effective power metric apply in a straightforward manner. In particular, elevation direction adds one more dimension to the overall hybrid precoding optimization problem (on top of azimuth directions and sub-arrays). A natural extension while computing the effective powers (for azimuth beams and elevation beams), then, is to perform the signal strength averaging (as described above) over the azimuth and elevation dimensions and the sub-arrays.

It may be noted that while the disclosed methods for reduced complexity precoding are motivated by the expected sparse multipath nature of the millimeter wave channel, channel sparsity is not a necessary requirement for the methods to be applied. The methods can be used to obtain reduced precoder search space in the context of any channel model.

It may further be noted that, when describing the embodiments disclosed above, the scenario of downlink (eNB to UE) communication has been considered. Using downlink reference symbols, methods have been disclosed to obtain dominant beams for reducing the complexity of hybrid precoder optimization. Analogous techniques are also directly applicable for uplink (UE to eNB) communication, as well. For instance, based on uplink reference symbol transmission from a UE to an eNB (such as channel sounding reference symbols), the eNB may use the effective power metric to obtain a set of dominant beam directions at the UE and at the eNB. Such dominant beam selection may be used, for instance, to reduce the complexity of precoder optimization (performed at the eNB) for the purpose of uplink communication. In addition, for time division duplexed (TDD) systems, such reduced complexity precoder optimization performed at the eNB using uplink channel sounding reference symbols may actually be beneficial for the purpose of downlink communication, as well. Even in FDD systems, dominant beam selection performed at the eNB based on uplink sounding reference symbols may be utilized for beam selection for the purpose of downlink communication.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses may be performed by more, fewer, or other components. The methods may include more, fewer, or other steps. Additionally, steps may be combined and/or performed in any suitable order.

Although the present disclosure has been described with example embodiments, various changes and modifications may be suggested to one skilled in the art. It is intended that the present disclosure encompass such changes and modifications as fall within the scope of the appended claims.

What is claimed is:

1. A method for providing low-complexity hybrid precoding, comprising:
identifying a subset of a plurality of precoding sets as a reduced search space; and
performing a search over the reduced search space for a preferred precoding set.

2. The method of claim 1, wherein identifying the reduced search space comprises determining at least one parameter for each of a plurality of beam directions.

3. The method of claim 2, wherein the at least one parameter comprises an effective received power, the effective received power determined by calculating an average of received power across different received reference symbols.

4. The method of claim 1, wherein identifying the reduced search space comprises at least one of:
identifying a plurality of dominant transmit beam directions or a plurality of dominant receive beam directions;
identifying a plurality of dominant transmit and receive beam pair combinations;
identifying a plurality of dominant transmit beam directions for each of a plurality of sub-arrays of transmit antennas or a plurality of dominant receive beam directions for each of a plurality of sub-arrays of receive antennas; and
identifying a plurality of dominant receive beam directions and identifying a plurality of dominant transmit beam directions based on the identified dominant receive beam directions.

5. The method of claim 1, wherein the size of the reduced search space is at least one of:
explicitly determined based on a tolerable search complexity;
implicitly determined based on picking beam directions with effective powers greater than a specified threshold; and
implicitly determined based on identifying, from within a plurality of beam directions, a smallest subset of beam directions that captures a specified fraction of a sum of effective powers in each of the plurality of beam directions.

6. The method of claim 1, wherein identifying the reduced search space comprises identifying dominant receive or transmit beam directions based on estimates of angles of arrival or angles of departure for corresponding communication channels.

7. The method of claim 6, wherein the dominant receive beam directions are identified as directions in a receiver codebook nearest to the corresponding communication channel's estimated angles of arrival and the dominant transmit beam directions are identified as directions in a transmitter codebook nearest to the corresponding communication channel's estimated angles of departure.

8. The method of claim 6, wherein the size of the reduced search space is at least one of:
explicitly determined based on a tolerable search complexity;
implicitly determined based on considering only those estimated angles of arrival or estimated angles of departure for those channel paths with estimated path gains greater than a specified threshold; and
implicitly determined based on identifying from within a plurality of estimated angles of arrival or angles of departure a subset of angles of arrival or angles of departure that captures a specified fraction of a sum of the estimated channel path gains.

9. A method for providing low-complexity hybrid precoding, comprising:
determining at least one parameter for each of a plurality of beam directions;
identifying a subset of the beam directions as dominant beam directions based on the at least one determined parameter; and
performing a search over the dominant beam directions for a preferred precoding set.

10. The method of claim 9, wherein the at least one parameter comprises an effective received power, the effective received power determined by performing a spatial smoothing of the received power across the beam directions and across sub-arrays of antennas at a transmitter and at a receiver.

11. The method of claim 9, wherein:
determining at least one parameter for each of a plurality of beam directions comprises determining at least one parameter for each of a plurality of transmit beam directions or determining at least one parameter for each of a plurality of receive beam directions; and
identifying a subset of the beam directions as dominant beam directions based on the determined parameters comprises identifying a subset of the transmit beam directions as dominant transmit beam directions or identifying a subset of the receive beam directions as dominant receive beam directions.

12. The method of claim 11, wherein:
the dominant transmit beam directions comprise P₁ beam directions and the dominant receive beam directions comprise P₂ beam directions; and
P₁ is different from P₂.

13. The method of claim 11, wherein:
for an i^{th} sub-array of transmit antennas, the dominant transmit beam directions comprise P_{1,1} beam directions; and
for a j^{th} sub-array of receive antennas, the dominant receive beam directions comprise P_{2,j} beam directions.

14. The method of claim 9, wherein the size of the subset of beam directions is at least one of:
explicitly determined based on a tolerable search complexity;
implicitly determined based on picking beam directions with effective powers greater than a specified threshold; and
implicitly determined based on identifying, from within a plurality of beam directions, a smallest subset of beam directions that captures a specified fraction of a sum of effective powers in each of the plurality of beam directions.

15. A user equipment (UE), comprising:
an array of sub-arrays of receive antennas;
a radio frequency (RF) precoder configured to provide RF precoding for each of the sub-arrays of antennas; and
a processing device configured to identify a subset of a plurality of precoding sets as a reduced search space and to perform a search over the reduced search space for a preferred precoding set.

16. The UE of claim 15, wherein the processing device is configured to identify the reduced search space by determining at least one parameter for each of a plurality of beam directions.

17. The UE of claim 15, wherein the processing device is configured to identify the reduced search space by identifying at least one of:
a plurality of dominant transmit beam directions or a plurality of dominant receive beam directions;
a plurality of dominant transmit and receive beam pair combinations;
a plurality of dominant transmit beam directions for each of a plurality of sub-arrays of transmit antennas or a plurality of dominant receive beam directions for each of a plurality of sub-arrays of receive antennas; and
a plurality of dominant receive beam directions and identifying a plurality of dominant transmit beam directions based on the identified dominant receive beam directions.

18. The UE of claim 15, wherein a size of the reduced search space is at least one of:
explicitly determined based on a tolerable search complexity;
implicitly determined based on picking beam directions with effective power greater than a specified threshold; and
implicitly determined based on identifying, from within a plurality of beam directions, a smallest subset of beam directions that captures a specified fraction of a sum of effective powers in each of the plurality of beam directions.

19. The UE of claim 15, wherein the processing device is configured to identify the reduced search space by identifying dominant receive or transmit beam directions based on estimates of angles of arrival or angles of departure for corresponding communication channels.

20. The UE of claim 19, wherein the processing device is configured to identify the dominant receive beam directions as directions in a receiver codebook nearest to the corresponding communication channel's estimated angles of arrival and to identify the dominant transmit beam directions as directions in a transmitter codebook nearest to the corresponding communication channel's estimated angles of departure.

21. The UE of claim 20, wherein a size of the reduced search space is at least one of:
explicitly determined based on a tolerable search complexity;
implicitly determined based on considering only those estimated angles of arrival or estimated angles of departure for those channel paths with estimated path gains greater than a specified threshold; and
implicitly determined based on identifying from within a plurality of estimated angles of arrival or angles of departure a subset of angles of arrival or angles of departure that captures a specified fraction of a sum of the estimated channel path gains.
